(19) United States
(12) Patent Application Publication
(10) Pub. No.: US 2021/0104212 A1
(43) Pub. Date: Apr. 8, 2021

(54) DISPLAY CONTROL DEVICE, AND NONTRANSITORY TANGIBLE COMPUTER-READABLE MEDIUM THEREFOR

(71) Applicant: DENSO CORPORATION, Kariya-city (JP)

(72) Inventors: Satoshi HORIHATA, Kariya-city (JP); Yasushi SAKUMA, Kariya-city (JP)

(21) Appl. No.: 17/101,757

(22) Filed: Nov. 23, 2020

Related U.S. Application Data
(63) Continuation of application No. PCT/JP2019/017331, filed on Apr. 24, 2019.

(30) Foreign Application Priority Data
May 29, 2018 (JP) 2018-102457

(51) Int. Cl. G09G 5/377; G06F 3/14; B60K 35/00; G01C 21/36

(52) U.S. Cl. CPC G09G 5/377; G06F 3/14; B60K 35/00; B60K 2370/166; G09G 2354/00; G09G 2380/10; B60K 2370/152; G01C 21/3626

(57) ABSTRACT

A display control device for a vehicle to control displaying a virtual image includes: a display image generator that generates a guide object display image for guiding a travel route; a distance recognition unit that recognizes a remaining distance from a current location of the vehicle to a guide target point; and a display controller that: displays a non-superimposed virtual image not to be superimposed on a specific superimposition target when the remaining distance is longer than a switch distance; and displays a superimposed virtual image to be superimposed on the specific superimposition target switched from the non-superimposed virtual image when the remaining distance becomes shorter than the switch distance.

### CROSS REFERENCE TO RELATED APPLICATION

The present application is a continuation application of International Patent Application No. PCT/JP2019/017331 filed on Apr. 24, 2019, which designated the U.S. and claims the benefit of priority from Japanese Patent Application No. 2018-102457 filed on May 29, 2018. The entire disclosures of all of the above applications are incorporated herein by reference.

### TECHNICAL FIELD

The present disclosure relates to a display control device for controlling display of a virtual image, and a non-transitory tangible computer-readable medium therefor.

### BACKGROUND

For example, a conceivable head-up display device displays not only an instruction image superimposed on a road surface of an instruction target such as a branch point at which a right/left turn is to be made, but also a guide image disposed above the instruction image.

### SUMMARY

A display control device for a vehicle to control displaying a virtual image may include: a display image generator that generates a guide object display image for guiding a travel route; a distance recognition unit that recognizes a remaining distance from a current location of the vehicle to a guide target point; and a display controller that: displays a non-superimposed virtual image not to be superimposed on a specific superimposition target when the remaining distance is longer than a switch distance; and displays a superimposed virtual image to be superimposed on the specific superimposition target switched from the non-superimposed virtual image when the remaining distance becomes shorter than the switch distance.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating an overall image of a vehicle-mounted configuration related to a virtual image display system;

FIG. 2 is a diagram illustrating an example of a display transition from a non-superimposed image to a superimposed virtual image and to a plurality of superimposed virtual images in a process in which route guidance is performed;

FIG. 3 is a chart representing a concept of the route guidance using a list of a correspondence relationship between a remaining distance to a guide target point and notification information;

FIG. 4 is a diagram illustrating an example of a scene in which consecutive branches are encountered; and

FIG. 5 is a flow chart illustrating details of a display control process performed in a display control device.

### DETAILED DESCRIPTION

In a conceivable head-up display device, as a result of an approach to the branch point serving as the instruction target, the instruction image is highlighted, while a visibility of the guide image is degraded.

In virtual image display, even in a state where a remaining distance to the branch point serving as the instruction target is long and the branch point is hard to visually recognize, not only the guide image is displayed, but also superimposed display of the instruction image is started. When such display of the instruction image is started, a forced task of recognizing a branch point which is hard to perceive in a real scene may be assigned to a passenger. This may interrupt smooth driving when the passenger approaches the branch point.

Thus, a display control device and a display control program are provided for implementing virtual image display capable of assisting a passenger to be able to drive smoothly, and a non-transitory tangible computer-readable medium therefor is also provided.

According to a first aspect of an example embodiment, a display control device for a vehicle to control displaying a virtual image to be visually recognized by a passenger of the vehicle, the display control device includes: a display image generator that generates a guide object display image for guiding a travel route of the vehicle to the passenger; a distance recognition unit that recognizes a remaining distance from a current location of the vehicle to a guide target point at which the guiding of the travel route in the guide object display image is provided; and a display controller that: displays a non-superimposed virtual image not to be superimposed on a specific superimposition target as the guide object display image when the remaining distance from the current location of the vehicle to the guide target point is longer than a switch distance; and displays a superimposed virtual image to be superimposed on the specific superimposition target as the guide object display image switched from the non-superimposed virtual image when the remaining distance becomes shorter than the switch distance.

According to a second aspect of an example embodiment, a display control program for a vehicle to control displaying a virtual image to be visually recognized by a passenger of the vehicle, the display control program causing at least one processor to function as: a display generator that generates a guide object display image for guiding a travel route of the vehicle to the passenger; a distance recognition unit that recognizes a remaining distance from a current location of the vehicle to a guide target point at which the guiding of the travel route in the guide object display image is provided; and a display controller that: displays a non-superimposed virtual image not to be superimposed on a specific superimposition target as the guide object display image when the remaining distance from the current location of the vehicle to the guide target point is longer than a switch distance; and displays a superimposed virtual image to be superimposed on the specific superimposition target as the guide object display image switched from the non-superimposed virtual image when the remaining distance becomes shorter than the switch distance.

According to a third aspect of an example embodiment, a non-transitory tangible computer readable storage medium comprising instructions being executed by a computer, the instructions for a vehicle to control displaying a virtual image to be visually recognized by a passenger of the vehicle, the instructions including: generating a guide object display image for guiding a travel route of the vehicle to the passenger; recognizing a remaining distance from a current location of the vehicle to a guide target point at which the guiding of the travel route in the guide object display image is provided; displaying a non-superimposed virtual image not to be superimposed on a specific superimposition target as the guide object display image when the remaining distance from the current location of the vehicle to the guide target point is longer than a switch distance; and displaying a superimposed virtual image to be superimposed on the specific superimposition target as the guide object display image switched from the non-superimposed virtual image when the remaining distance becomes shorter than the switch distance.

In accordance with these aspects, at a stage at which the remaining distance to the guide target point is longer than the switch distance, the non-superimposed virtual image is displayed. Consequently, the guide target point is not clearly represented by the displayed guide object. This prevents assignment of such a forced task as to recognize the guide target point that is hard to perceive. Then, at a stage at which the remaining distance to the guide target point becomes shorter than the switch distance, the superimposed display is displayed as the displayed guide object. Such a change in the display of the displayed guide object allows the passenger to pay attention to the superimposition target at timing at which recognition of the superimposition target becomes easy. As a result, the virtual image display can assist the passenger to be able to drive smoothly.

A display control device 100 according to an embodiment of the present disclosure is included, together with a head-up display (hereinafter abbreviated as “HUD”) device 30 and the like, in a virtual image display system 10 used in a vehicle A. The virtual image display system 10 displays a virtual image Vi which is visually recognizable by a passenger (e.g., driver) of the vehicle A. The virtual image display system 10 uses the virtual image Vi to present various information related to the vehicle A to the driver.

The display control device 100 is mutually communicative with another vehicle-mounted configuration via a communication bus of a vehicle-mounted network. The communication bus is directly or indirectly electrically connected to, e.g., a navigation information providing unit 21, an ADAS information providing unit 22, a host vehicle information providing unit 27, a driver information providing unit 28, an vehicle-mounted device 40, and the like.

Each of the navigation information providing unit 21 and the ADAS information providing unit 22 is a configuration that provides route guidance information related to route guidance to the display control device 100. The navigation information providing unit 21 is a configuration including at least a navigation device mounted in the vehicle A, and has a map database, a GNSS (Global Navigation Satellite System) receiver, and vehicle exterior communication equipment. The navigation information providing unit 21 outputs, to the communication bus, information on a route to a destination set by the driver, a current position and a current direction of a host vehicle, congestion information representing a degree of congestion of a road, type information representing a road type, information such as coordinates and a shape of an intersection for which route guidance is to be performed, and the like each as the route guidance information.

Note that the navigation information providing unit 21 may also be a configuration which is communicative with a mobile terminal capable of executing a navigation application. From the navigation information providing unit 21 thus configured, map data, route information, and the like each acquired by communication with the mobile terminal are provided as the route guidance information to the display control device 100.

The ADAS information providing unit 22 includes a locator 23, an external sensor 24, a drive assist control system 25, and a high-accuracy map database 26. The locator 23 performs composite positioning using a combination of a positioning signal received by the GNSS receiver, measurement information from an inertia sensor, the external sensor 24, and the like, and high-accuracy map information to thus generate such high-accuracy position information as to indicate a lane traveled by the vehicle A.

The external sensor 24 is configured to include a front camera, millimeter/quasi-millimeter wave radars, a lidar, a sonar, and the like. The external sensor 24 detects, from around the vehicle A, especially from a range in front of the vehicle A, a stationary object and a moving object in real time. For example, the external sensor 24 detects a road sign and a traffic signal each as the stationary object and a pedestrian, a cyclist, and the like each as the moving object.

The drive assist control system 25 uses the high-accuracy position information from the locator 23, external sensing information from the external sensor 24, the high-accuracy map information acquired from the high-accuracy map database 26, and the like to assist the driver with a driving operation. The drive assist control system 25 includes functional units which implement automated driving functions such as ACC (Adaptive Cruise Control), LTC (lane trace control), and LKA (Lane Keeping Assist). In addition, the drive assist control system 25 includes functional units which implement a collision avoiding function such as FCW (Forward collision warning) and AEB (Automatic emergency braking).

The high-accuracy map database 26 stores the high-accuracy map information as map data higher in accuracy than the map data stored in the navigation information providing unit 21. The high-accuracy map includes not only information such as center lines of roads and connections between the roads, but also information such as three-dimensional positions, shapes, and the like of pedestrian crosswalks, stop lines, traffic signs, traffic signals, and the like. The high-accuracy map database 26 stops providing the high-accuracy map information in an area where the high-accuracy map is not complete.

The ADAS information providing unit 22 provides, as the route guidance information, the high-accuracy position information, drive assist control information from the drive assist control system 25, the high-accuracy map information, and the like each described above to the display control device 100.

The host vehicle information providing unit 27 is configured to include a plurality of vehicle-mounted sensors which measure a state of the vehicle A. The vehicle-mounted sensors include a vehicle speed sensor, an acceleration sensor, a gyro sensor, and the like. The host vehicle information providing unit 27 provides, as host vehicle movement information, information on the vehicle A such as a current vehicle speed, a current acceleration, a current angular speed, and a current vehicle attitude to the display control device 100.

The driver information providing unit 28 is configured to include at least a driver status monitor (hereinafter abbreviated as “DSM”) mounted in the vehicle A, and has an infrared light source, an infrared camera, and an image analysis unit. The driver information providing unit 28 acquires information on the driver such as an eye point EP, a line-of-sight direction, and an eye-opening degree through analysis of a face image captured using the infrared camera. The driver information providing unit 28 provides the sensing information acquired from the driver to the display control device 100.

The vehicle-mounted device 40 is an electronic control unit mounted in the vehicle A and electrically connected to vehicle-mounted display elements such as a combination meter 41, a multi-information display (MID) 42, and a center information display (CID) 43. The vehicle-mounted device 40 integrally controls presentation of information to the driver in response to a control request to each of the vehicle-mounted display elements.

For example, on a display screen of the CID 43, the map data, information on a route toward a destination, and the like are displayed by the navigation device. The display screen of the CID 43 is a touch panel 44 capable of receiving a touch operation by the driver or the like. Based on an operation input to the touch panel 44, the setting of the destination, a change to set values, and the like can be performed.

The HUD device 30 is electrically connected to the display control device 100 and acquires video data generated by the display control device 100. The HUD device 30 is configured to include a projector, a screen, a magnifying optical system, and the like. The HUD device 30 is contained in a containing space in an instrument panel below a windshield WS.

The HUD device 30 projects light of a displayed image formed as the virtual image Vi toward a projection range PA of the windshield WS. The light projected toward the windshield WS is reflected by the projection range PA toward a driver seat to be perceived by the driver. The driver can visually recognize display in which the virtual image Vi is superimposed on a superimposition target in a front scene seen through the projection range PA.

The projection range PA is a range in which light can be projected by the HUD device 30 and serves as a range in which the virtual image Vi can be displayed when viewed from the driver. The projection range PA is a limited region corresponding to a portion of the entire windshield WS. A field angle of the projection range PA is set to, e.g., 12° in a horizontal (lateral) direction, while being set to 4° in a perpendicular (vertical) direction. The HUD device 30 allows the virtual image Vi to be displayed while being superimposed only on an object within a range that can be seen through the projection range PA when the front view is viewed from the eye point EP of the driver.

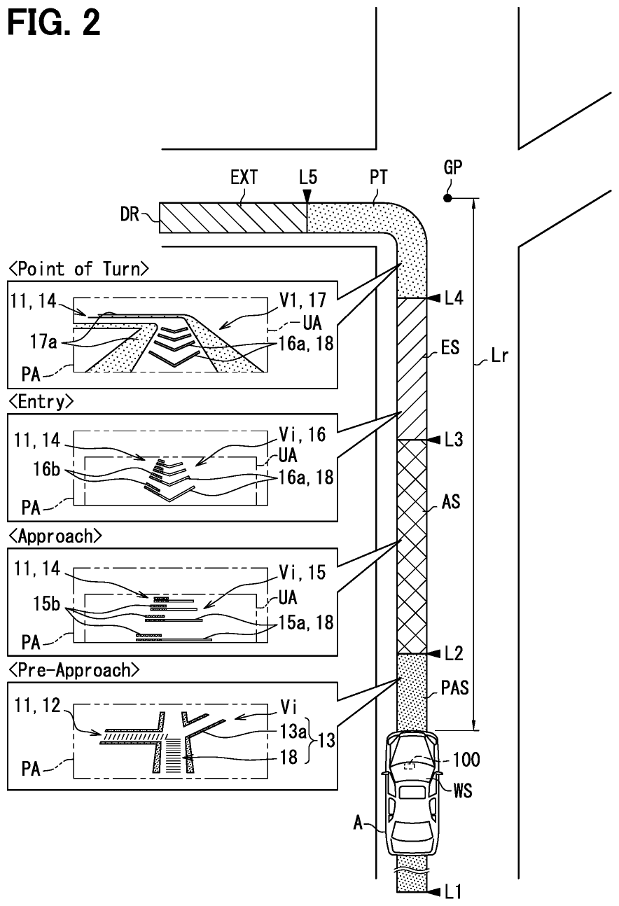

The virtual image Vi is formed in a space at a position relatively distant from the windshield WS, specifically about 10 to 20 m from the eye point EP in a forward direction of the vehicle A. The virtual image Vi includes a superimposed virtual image 14 and a non-superimposed virtual image 12 (see FIG. 2). The superimposed virtual image 14 is displayed while being superimposed on the specified superimposition target that can be seen through the projection range PA such as, e.g., a leading vehicle, a pedestrian, or a road surface. The superimposed virtual image 14 is capable of moving following the superimposition target in such a manner as to be relatively fixed to the superimposition target. The superimposed virtual image 14 serves as a so-called augmented reality (hereinafter abbreviated as “AR”) displayed object to present information to the driver. Meanwhile, the non-superimposed virtual image 12 is a non-AR displayed object which is not superimposed on the specified superimposition target, but is merely displayed while being superimposed on the front scene. The non-superimposed virtual image 12 is displayed in such a manner as to be, e.g., fixed to the windshield WS.

The display control device 100 is an electronic control unit that controls display of the virtual image Vi by the HUD device 30. A control circuit in the display control device 100 is configured to include, as a main component, a computer including a processing unit 61, a RAM 62, a memory device 63, and an input/output interface. The processing unit 61 is a configuration including at least one of a CPU (Central Processing Unit), a GPU (Graphics Processing Unit), and the like.

In the memory device 63, various programs to be executed by the processing unit 61 are stored. In the memory device 63, a plurality of application programs (50a to 50e) for generating contents to be displayed as virtual images, an information presentation management program for integrally controlling display of the contents as the virtual images, and the like are stored as display control programs. The display control device 100 has, as functional blocks based on the information presentation management program, a common information generation block 71 and an integral display control block 73.

The common information generation block 71 acquires, from the communication bus, information used commonly by the individual superimposed display applications 50a to 50e and the integral display control block 73, which is required to determine design of the virtual image Vi. The common information generation block 71 can acquire, from the communication bus, the drive assist control information, the host vehicle movement information, the sensing information from the driver, and the like in addition to the route guidance information.

Based on the information provided by the common information generation block 71, the superimposed display applications 50a to 50e perform generation of contents related to the ADAS function and to a cockpit function and the setting of display flags therefor. The individual superimposed display applications 50a to 50e are associated with the ACC function, the LKA function, and the FCW function of the drive assist control system 25 and with the navigation device or the like. Each of the superimposed display applications 50a to 50e individually determines the content to be displayed as the virtual image based on the provided information and sends a display request to the integral display control block 73.

Based on the display request from each of the superimposed display applications 50a to 50e, the integral display control block 73 generates the video data of the virtual image Vi using the information provided by the common information generation block 71. The integral display control block 73 includes a display management unit 74, a superimposed display correction unit 75, and a graphic output unit 76.

The display management unit 74 is a functional unit that adjusts the contents to be displayed as the virtual image Vi. The display management unit 74 selects the content having a higher priority, from among the contents corresponding to the acquired display requests, and sets the selected content as a target of the virtual image display. By such setting, the content notifying the driver of information having a high priority (degree of emergency), such as the content related to, e.g., the FCW function, is substantially necessarily set as the display target and promptly displayed.

Based on the information acquired by the common information generation block 71, the superimposed display correction unit 75 generates correction information for correctly superimposing the superimposed virtual image 14 on the superimposition target. The correction information is information for adjusting a position at which the virtual image Vi is to be formed on a virtual line three-dimensionally connecting the superimposition target and the eye point EP. The superimposed display correction unit 75 sequentially generates the correction information considering a relative position of the superimposition target, the position of the eye point EP, the attitude of the vehicle, and the like.

The graphic output unit 76 generates the video data by a process of drawing an original image of the content selected by the display management unit 74. The graphic output unit 76 adjusts, based on the correction information from the superimposed display correction unit 75, a position at which the original image is to be drawn and a shape of the drawn image in each of frames of the video data. The graphic output unit 76 outputs, toward the HUD device 30, each of the generated video data sets in a preliminarily defined video format.

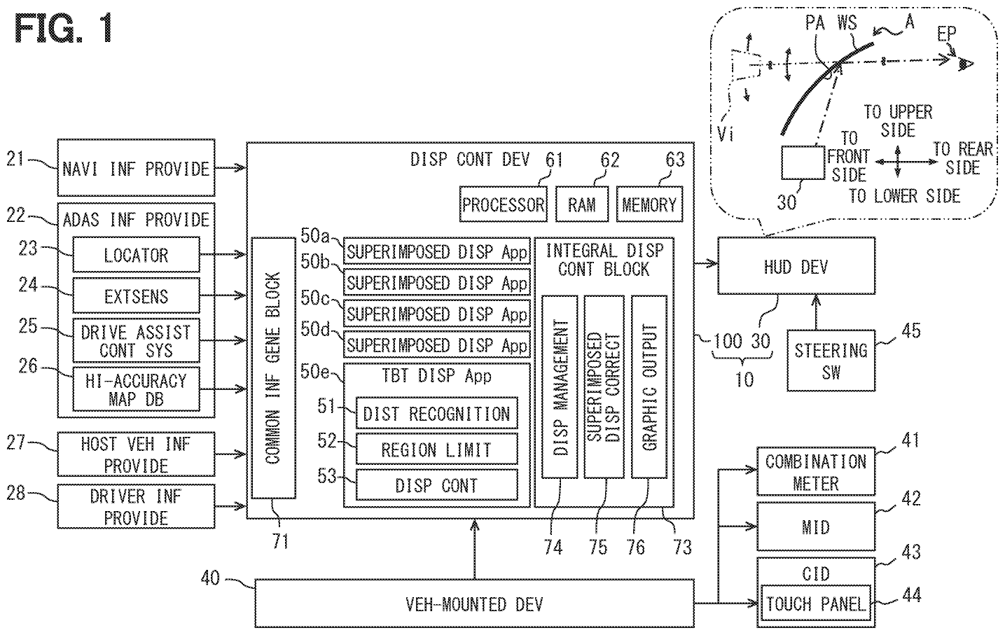

In the display control device 100 illustrated in FIGS. 1 and 2, a TBT display application 50e is one of the superimposed display applications 50a to 50e. The TBT display application 50e controls, based on the route information, display of a displayed guide object 11 that gives, to the driver, guidance on a travel route DR of the vehicle A. The display of the displayed guide object 11 is started with, e.g., an approach to the guide target point GP such as, e.g., an intersection or a branch and ended by passage through the guide target intersection. Based on the display request from the TBT display application 50e, the integral display control block 73 generates the video data including the displayed guide object 11. The TBT display application 50e includes a distance recognition unit 51, a region limiting unit 52, and a display control unit 53 as sub-functional blocks that control the display of the displayed guide object 11.

The distance recognition unit 51 recognizes, based on the route guidance information, the current position and the current direction of the vehicle A, coordinates of the guide target point, a shape of the guide target intersection serving as the guide target point GP, a direction in which the vehicle A exits the guide target intersection based on the travel route DR, a remaining distance Lr from the vehicle A to the guide target intersection, and the like. When there is the high-accuracy position information from the common information generation block 71, the distance recognition unit 51 can recognize the current position, the current direction, and the like of the vehicle A using the high-accuracy position information.

The region limiting unit 52 limits a display permitted range UA in which the superimposed virtual image 14 is permitted to be displayed to a portion of the projection range PA. The region limiting unit 52 defines the display permitted range UA below the projection range PA such that a center of the display permitted range UA is located below a center of the projection range PA. The display permitted range UA is defined so as to include a lower edge of the projection range PA. When viewing the projection range PA from the eye point EP, the driver visually recognizes a road surface in front of the vehicle A through the display permitted range UA. Therefore, the display permitted range UA is a range in which misaligned superimposition resulting from a road shape such as a slope or a curve is likely to be minimized.

The region limiting unit 52, which is capable of extending/reducing the display permitted range UA, upwardly extends the display permitted range UA. The display permitted range UA may be extended to, e.g., the entire projection range PA. In an example, as the remaining distance Lr to the guide target intersection is shorter, the region limiting unit 52 upwardly moves an upper edge of the display permitted range UA to define the larger display permitted range UA.

In another example, the region limiting unit 52 changes the display permitted range UA based on recognition information related to a front side of the vehicle A. The recognition information includes sensing information from a leading vehicle based on the external sensing information, information on a road shape such as a slope or a curve based on the external sensing information and on the high-accuracy map information, and the like. When a leading vehicle that may possibly overlap the virtual image Vi is not sensed, the region limiting unit 52 upwardly extends the display permitted range UA. Additionally, when the shape of the road in front of the vehicle is successfully recognized with high accuracy, the region limiting unit 52 upwardly and laterally extends the display permitted range UA in accordance with a mode of the slope and the curve.

The region limiting unit 52 can change the setting of the display permitted range UA based on an input operation by the passenger such as the driver. Such an operation is input to an operation unit of, e.g., the touch panel 44 or a steering switch 45. The driver can set an initial size of the display permitted range UA before extension and whether or not to permit the display permitted range UA to be extended by inputting the operation to the operation unit.

The display control unit 53 switches the object displayed as the virtual image based on the remaining distance Lr from the vehicle A to the guide target point GP to indicate, to the driver, a driving behavior corresponding to the remaining distance Lr. The display control unit 53 sets, as thresholds to be compared to the remaining distance Lr, individual threshold distances such as a display start distance L1, a switch distance L2, an approach distance L3, an entrance distance L4, and an exit distance L5. The display control unit 53 also changes notification information of which the driver is to be notified by dynamically switching the displayed virtual image based on the comparison of the remaining distance Lr to each of the threshold distances (L1 to L5) to indicate a required driving behavior to the driver at required timing.

The display control unit 53 switches the displayed guide object 11 from the non-superimposed virtual image 12 to the superimposed virtual image 14 based on the remaining distance Lr to the guide target point GP. Specifically, when the remaining distance Lr is longer than the switch distance L2, the distance recognition unit 51 displays the non-superimposed virtual image 12 as the displayed guide object 11. Then, when the remaining distance Lr from the vehicle A to the guide target point GP becomes shorter than the switch distance L2, the display control unit 53 displays the superimposed virtual image 14 as the displayed guide object 11 instead of the non-superimposed virtual image 12. The superimposed virtual image 14 is displayed at substantially the same position as that of the non-superimposed virtual image 12 to indicate that the superimposed virtual image 14 is the displayed guide object 11 associated with the non-superimposed virtual image 12. In other words, at least a portion of a range in which the superimposed virtual image 14 is displayed overlaps a range in which the non-superimposed virtual image 12 is displayed.

The display control unit 53 changes the mode of the superimposed virtual image 14 based on the remaining distance Lr to the guide target point GP. The superimposed virtual image 14 displayed as the displayed guide object 11 includes a lane notification virtual image 15, a deceleration notification virtual image 16, a route notification virtual image 17, a completion notification virtual image, and the like. The display control unit 53 sequentially switches one of the superimposed virtual images 14 to another based on a result of comparison of the remaining distance Lr to each of the threshold distances (L2 to L5).

To adjust the timing of presenting information to the driver, the display control unit 53 can change each of the threshold distances (L1 to L5) for changing the mode of the non-superimposed virtual image 12 and the superimposed virtual image 14 based on the traveling environment information of a road serving as the travel route DR and on an operation input by the passenger such as the driver. Through the changing of each of the threshold distances, each of timing of starting the display of the non-superimposed virtual image 12 and the superimposed virtual image 14 and state transition timing for changing the mode of the superimposed virtual image 14 is adjusted.

For example, the display control unit 53 uses, as the traveling environment information, road type information, the congestion information, or the like included in the route guidance information. When the vehicle is traveling on a road having a fast traffic flow such as, e.g., a national road, the display control unit 53 sets each of the threshold distances longer than that when the vehicle is traveling on a road having a slow traffic flow based on the road type information. Meanwhile, when assuming that a road is congested based on the congestion information, the display control unit 53 sets each of the threshold distances (L1 to L5) based on time. Specifically, the display control unit 53 sets, based on an expected arrival time at the guide target intersection, each of the threshold distances (L1 to L5) before specified seconds before the vehicle arrives at the guide target intersection.

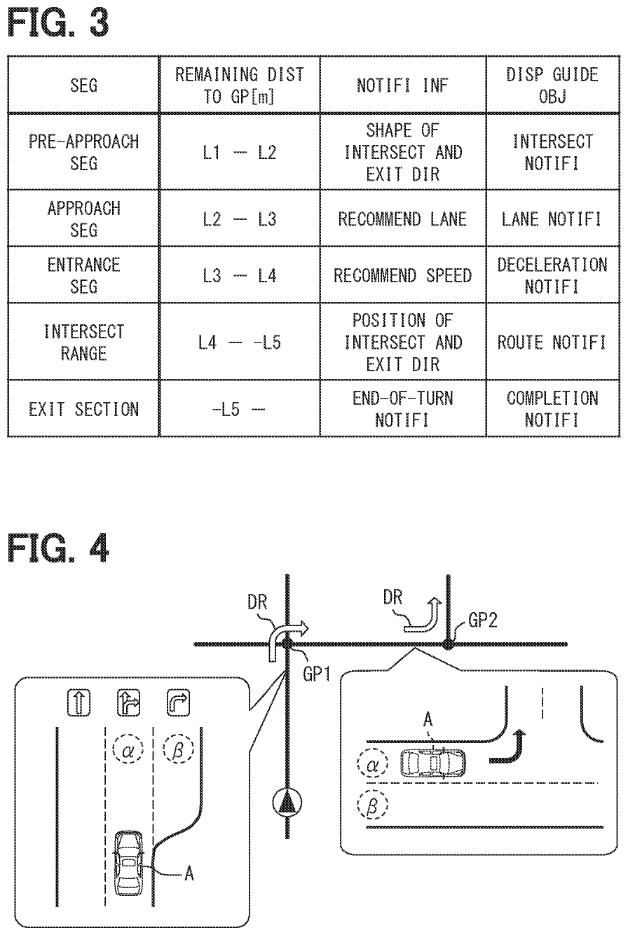

Next, based on FIGS. 2 and 3, details of a state transition of the displayed guide object 11 resulting from the passage through the one guide target point GP (guide target intersection) will be described with reference to FIG. 1. As described above, the TBT display application 50e causes an intersection notification virtual image 13 serving as the non-superimposed virtual image 12 to be temporarily displayed as the displayed guide object 11, and then causes the lane notification virtual image 15, the deceleration notification virtual image 16, the route notification virtual image 17, and the completion notification virtual image each serving as the superimposed virtual image 14 to be sequentially displayed. In each of the virtual images Vi displayed as the displayed guide object 11, a plurality of route linear portions 18 are drawn as a common display element. Each of the route linear portions 18 has a shape linearly extending along a width direction of the road surface. The route linear portions 18 are arranged along the road surface serving as the travel route DT, while being spaced apart from each other.

The intersection notification virtual image 13 is the displayed guide object 11 that notifies the driver of an approach to the guide target intersection as the guide target point GP. The intersection notification virtual image 13 is displayed in a mode in which an intersection-shaped image 13a representing an overall shape of the guide target intersection is combined with the large number of route linear portions 18 representing the direction in which the vehicle exits the guide target intersection. The intersection notification virtual image 13 is the non-AR displayed object which is displayed as a virtual image having a size occupying substantially the entire projection range PA in a state where the intersection notification virtual image 13 is not superimposed on the specified superimposition target.

The intersection notification virtual image 13 is displayed as a virtual image in a pre-approach section PAS defined before the guide target point GP. The pre-approach section PAS is a section in which the remaining distance Lr to the guide target point GP is between the display start distance L1 and the switch distance L2. For example, the display start distance L1 is set at a point at which the remaining distance Lr is 700 mm. For example, the switch distance L2 is set at a point at which the remaining distance Lr is 300 m. The display of the intersection notification virtual image 13 is started at timing at which the remaining distance Lr equals the display start distance L1 and is ended at timing at which a specified time (several seconds) has elapsed from the start of the display. The display of the intersection notification virtual image 13 is not continued until the remaining distance Lr equals the switch distance L2 so as to prevent the intersection notification virtual image 13 from covering the entire projection range PA for a long period of time.

The TBT display application 50e indicates a moving direction of the vehicle A at the guide target intersection by showing an animation in which the plurality of route linear portions 18 arranged along the travel route DR are sequentially displayed from the front side (lower side) first. The TBT display application 50e ends the display of the intersection notification virtual image 13 at timing at which a specified time elapses from the start of the display. The specified time is defined in advance to end after the animation of the route linear portions 18 is displayed once or a plurality of times. The number of times such an animation is repeated can be changed based on, e.g., the sensing information obtained by the DSM from the driver. By way of example, when inattentive driving by the driver, such as taking eyes off the projection range PA, is sensed, the TBT display application 50e can increase the number of times the animation is repeated by elongating the specified time.

The lane notification virtual image 15 is the displayed guide object 11 that notifies the driver of a recommended lane to which the driver is to move the vehicle A before the vehicle A reaches the guide target intersection. The lane notification virtual image 15 is displayed in the display permitted range UA. The lane notification virtual image 15 includes road surface images 15a and direction notification images 15b. The road surface images 15a are superimposed on the road surface in front of the vehicle A. The road surface images 15a are represented by the plurality of route linear portions 18 each linearly extending along the width direction of the road. The road surface images 15a are display elements drawn in predetermined shapes, which are displayed in substantially invariable shapes irrespective of a configuration of the road before the guide target intersection.

The direction notification images 15b are displayed above or below each of the route linear portions 18 in adjacent relation thereto. The direction notification images 15b linearly extend along the route linear portions 18 to have lengths shorter than those of the route linear portions 18. A color in which the direction notification images 15b are displayed is different from a color in which the road surface images 15a are displayed. In addition, a portion of each of the route linear portions 18 facing the direction notification image 15b is displayed in substantially the same color as that of the direction notification image 15b.

Relative lateral positions of the direction notification images 15b with respect to the road surface images 15a indicate a direction in which the vehicle makes a right/left turn or the like at the guide target intersection and in which the vehicle A is moved to the guide target intersection. Specifically, when the vehicle A is required to be moved to a rightmost lane before reaching the guide target intersection, the direction notification images 15b are displayed along respective right ends of the road surface images 15a. Meanwhile, when the vehicle A is required to be moved to a leftmost lane before reaching the guide target intersection, the direction notification images 15b are displayed along respective left ends of the road surface images 15a.

The lane notification virtual image 15 is displayed in an approach section AS. The approach section AS is defined to be closer to the guide target point GP than the pre-approach section PAS along the travel route DR. The approach section AS is a section in which the remaining distance Lr to the guide target point GP is between the switch distance L2 and the approach distance L3. By way of example, the approach distance L3 is set at a point at which the remaining distance Lr is 100 m. The display of the lane notification virtual images 15 is started at timing at which the remaining distance Lr equals the switch distance L2 and continued until the remaining distance Lr equals the approach distance L3.

The deceleration notification virtual image 16 is the displayed guide object 11 that notifies the driver of a recommended speed when the vehicle enters the guide target intersection to urge the driver to decelerate the vehicle. Similarly to the lane notification virtual image 15, the deceleration notification virtual image 16 is displayed in the display permitted range UA and includes road surface images 16a and direction notification images 16b. Unlike the road surface images 15a, the road surface images 16a include the plurality of route linear portions 18 each having a V-shape. The road surface images 16a including the downwardly protruding (or upwardly protruding) route linear portions 18 are superimposed on the road surface in front of the vehicle A. Using shape changes from the road surface images 15a to the road surface images 16a, the deceleration notification virtual image 16 allows the driver to intuitively sense a distance to the guide target intersection. The direction notification images 16b are combined with the road surface images 16a to continuously represent a lateral direction in which the vehicle A is to be moved to the guide target point GP.

When determining that the speed at which the vehicle A enters the guide target intersection is excessively high based on the traveling speed of the vehicle A, the deceleration notification virtual image 16 is changed to a mode which gives warning of the highness of the traveling speed. For example, the TBT display application 50e sets a speed threshold corresponding to the remaining distance Lr. When the traveling speed of the vehicle A is over the speed threshold, a color in which the deceleration notification virtual image 16 is displayed is changed to, e.g., red, amber, or the like.

The deceleration notification virtual image 16 is displayed in an entrance section ES. The entrance section ES is defined to be closer to the guide target point GP than the approach section AS along the travel route DR. The entrance section ES is a section in which the remaining distance Lr to the guide target point GP is between the approach distance L3 and the entrance distance L4. By way of example, the entrance distance L4 is set at a point at which the remaining distance Lr is 30 m. The display of the deceleration notification virtual image 16 is started at timing at which the remaining distance Lr equals the approach distance L3 and continued until the remaining distance Lr equals the entrance distance L4.

The route notification virtual image 17 is the displayed guide object 11 that notifies the driver of a position of the guide target intersection at which the driver is to be make a right/left turn or the like and exit of the vehicle from the guide target intersection. Through upward extension of the display permitted range UA, the route notification virtual image 17 is displayed in such a manner as to use substantially the entire projection range PA. The route notification virtual image 17 includes the road surface images 16a of the deceleration notification virtual images 16, which are continuously displayed therefrom, and route images 17a. The route images 17a are disposed on both sides of the road surface images 16a to extend in the form of a band along the travel route DR. The route notification virtual image 17 is superimposed on the road surface in front including the guide target point GP, and represents a direction in which the vehicle is to exit the guide target intersection by using curving of the route images 17a along the travel route DR.

The route notification virtual image 17 is displayed in an intersection range PT. The intersection range PT is defined so as to include the guide target point GP. The intersection range PT corresponds to an area where the remaining distance Lr to the guide target point GP is between the entrance distance L4 and the exit distance L5. By way of example, the exit distance L5 is set at a point at which the remaining distance Lr is −30 m, i.e., a point 30 m away from the guide target point GP in the exit direction. The display of the route notification virtual image 17 is started at timing at which the remaining distance Lr equals the entrance distance L4 and continued until the remaining distance Lr equals the exit distance L5.

The completion notification virtual image is the displayed guide object 11 that notifies the driver of the end of a right/left turn at the guide target intersection. The completion notification virtual image includes a road surface image to be superimposed on the road surface in front. By showing an animation in which the plurality of route linear portions 18 each displayed as the road surface image are sequentially displayed from the front side (lower side) first, the completion notification virtual image notifies the driver that the right/left turn is ended, while urging the driver to start a normal travel along the road. The completion notification virtual image is displayed in an exit section EXT. The exit section EXT is defined to be farther away from the guide target point GP than the intersection range PT along the travel route DR. The display of the completion notification virtual image is started at timing at which the remaining distance Lr equals the exit distance L5 and ended at timing at which the animation is repeated a predetermined number of times.

When the travel route DR has consecutive branches as illustrated in FIG. 4, the TBT display application 50e can change the mode in which the lane notification virtual image 15 and the deceleration notification virtual image 16 are displayed. The TBT display application 50e can acquire, as the route guidance information, a recommended lane to be traveled by the vehicle A from the navigation device. When having successfully acquired the recommended lane, the TBT display application 50e displays, in the approach section AS before a first guide target point (branch point GP1) and in the entrance section ES, the lane notification virtual image 15 and the deceleration notification virtual image 16 in a display mode different from that when a normal right/left turn is to be made.

Specifically, before the first branch point GP1, the TBT display application 50e causes the lane notification virtual image 15 in which the direction notification images 15b are disposed at centers of the road surface images 15a and the deceleration notification virtual image 16 in which the direction notification images 16b are disposed at centers of the road surface images 16a to be sequentially displayed. Using the lane notification virtual image 15 and the deceleration notification virtual image 16 in such a display mode, the TBT display application 50e induces the vehicle not into the rightmost lane (see 13 in FIG. 4), but into a center lane (see a in FIG. 4). When the driver has successfully moved the vehicle A to the center lane based on the display described above, a left turn at a second guide target point (branch point GP2) can smoothly be made.

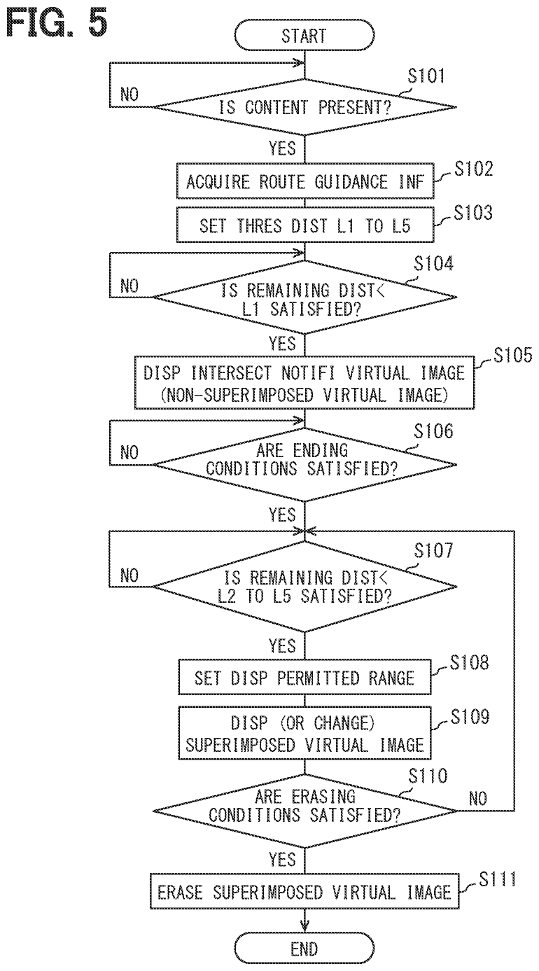

To implement the display of the displayed guide object 11 described heretofore, based on FIG. 5, details of a display control process performed by the display control device 100 will specifically be described with reference to FIGS. 1 and 2. The display control process illustrated in FIG. 5 is started using, as a trigger, occurrence of a specified event such as, e.g., completion of route setting in the navigation device or the like.

In S101, the display control device 100 determines whether a content to be displayed, such as the displayed guide object 11, is present or absent. When determining that a content to be displayed is present in S101, the display control device 100 advances the process to S102. Meanwhile, when determining that a content to be displayed is absent, the display control devices 100 repeats S101 to wait for a content, such as the displayed guide object 11, to occur.

In S102, the display control device 100 acquires the route guidance information or the like, and advances the process to S103. The route guidance information acquired in S102 includes the recognition information, the traveling environment information of the road, and the like. In S103, the display control device 100 sets the individual threshold distances (L1 to L5) based particularly on the traveling environment information of the road included in the route guidance information acquired in S102, and advances the process to S104.

In S104, the display control device 100 recognizes the remaining distance Lr and determines whether or not the most recent remaining distance Lr is less than the display start distance L1. When the remaining distance Lr is equal to or longer than the display start distance L1, the display control device 100 repeats S104 to wait for an approach to the guide target point G. Then, at timing at which the remaining distance Lr becomes less than the display start distance L1, the display control device 100 advances the process to S105.

In S105, the display control device 100 displays the intersection notification virtual image 13, and advances the process to S106. In S106, the display control device 100 determines whether or not conditions for ending the display of the intersection notification virtual image 13 are satisfied. As described above, the time elapsed from the start of the display, the number of times the animation is repeated, and the like are set as the conditions for ending the display of the intersection notification virtual image 13. When determining that the conditions for ending the display are satisfied in S106, the display control device 100 advances the process to S107.

In S107, the display control device 100 sequentially compares the remaining distance Lr to each of the threshold distances L2 to L5. In S107, the display control device 100 recognizes the remaining distance Lr, and determines whether or not the most recent remaining distance Lr is less than the switch distance L2. When the remaining distance Lr is equal to or longer than the switch distance L2, the display control device 100 repeats S107 to wait for an approach to the guide target point GP. Then, at timing at which the remaining distance Lr equals the switching distance L2, the display control device 100 advances the process to S108.

In S108, the display control device 100 sets the display permitted range UA corresponding to the presence or absence of a leading vehicle and to the road shape in front based on the recognition information acquired in S102, and advances the process to S109. The display control device 100 increases the size of the display permitted range UA set in S108 as the number of times repetition is performed increases. In S109, the display control device 100 starts the display of the lane notification virtual image 15, and advances the process to S110. Through repetition of S107 to S109 described above, the superimposed virtual image 14 is sequentially switched to the lane notification virtual image 15, to the deceleration notification virtual image 16, to the route notification virtual image 17, and to the completion notification virtual image.

In S110, the display control device 100 determines whether or not conditions for erasing the superimposed virtual image 14 are satisfied. The erasing conditions are conditions set in advance. Examples of the erasing conditions include a distance from the guide target intersection equal to or longer than a predetermined distance, a lapse of a predetermined time from the start of the display of the completion notification virtual image, deviation of the vehicle A from the travel route DR, and the like. When determining that the erasing conditions are not satisfied in S110, the display control device 100 returns the process to S107. As a result, the display control device 100 compares the remaining distance Lr to the next threshold distance. Meanwhile, when determining that the erasing conditions are satisfied in S110, the display control device 100 advances the process to S111. In S111, the display control device 100 turns OFF the display of the superimposed virtual image 14, and ends the display control process.

In the present embodiment described heretofore, at a stage at which the remaining distance Lr to the guide target point GP is longer than the switch distance L2, the non-superimposed virtual image 12 is displayed. Therefore, the guide target point GP is not clearly represented by the displayed guide object 11. As a result, it is possible to prevent assignment of such a forced task of recognizing the distantly located guide target point GP hard to perceive.

Then, at a stage at which the remaining distance Lr to the guide target point GP becomes shorter than the switch distance L2, the superimposed virtual image 14 is displayed as the displayed guide object 11. Using such a change in virtual image display, the displayed guide object 11 allows the driver to pay attention to the superimposition target at timing at which recognition of the superimposition target becomes easy. As a result, the virtual image display can assist the driver to be able to drive smoothly.

In addition, the region limiting unit 52 in the present embodiment limits the display permitted range UA in which the superimposed virtual image 14 is permitted to be displayed to a portion of the projection range PA. Due to such a limit to the display range, a region at the field angle of the HUD device 30 where the superimposed virtual image 14 is easily displaced from the superimposition target is no longer used for the AR display. As a result, the driver is less likely to feel discomfort due to misaligned superimposition of the superimposed virtual image 14.

In the present embodiment, the display permitted range UA is defined in a rather lower range of the projection range PA. Accordingly, the superimposed virtual image 14 such as the lane notification virtual image 15 or the deceleration notification virtual image 16 is drawn at a position where it is highly probable that the superimposed virtual image 14 overlaps the road surface in front irrespective of a change in the attitude of the vehicle A, the road shape, or the like. Due to a limit to the display range as described above, misaligned superimposition due to a road shape such as a slope or a curve, coverage of a leading vehicle by the superimposed virtual image 14, or the like is less likely to occur.

Additionally, in the present embodiment, in the intersection range PT in which the remaining distance Lr to the guide target point GP is short, the region limiting unit 52 defines the display permitted range UA larger than that set in each of the approach section AS and the entrance section ES in which the remaining distance Lr is longer. Through adjustment/control of the display permitted range UA as described above, the display control unit 53 can display the large superimposed virtual image 14 at a stage at which the region where the misaligned superimposition is likely to occur is reduced. Therefore, information presented by the superimposed virtual image 14 is more easily recognizable by the driver.

Additionally, in the present embodiment, the display permitted range UA is varied based on the recognition information related to the front side of the vehicle. Therefore, the display control unit 53 can appropriately display the superimposed virtual image 14 which is optimal to a state of the front range such as the road shape or the presence or absence of a leading vehicle. As a result, information presented by the superimposed virtual image 14 is far more easily recognizable by the driver.

Also, in the present embodiment, the mode of the superimposed virtual image 14 is sequentially changed based on the remaining distance Lr to the guide target point GP. Such a state transition of the superimposed virtual image 14 allows the driver to intuitively recognize the remaining distance Lr to the guide target point GP even when the remaining distance Lr to the guide target point GP is not directly displayed as the virtual image. Thus, a driving behavior corresponding to the remaining distance Lr can be suggested to the driver, and therefore the driver more smoothly performs a driving operation such as a lane shift or deceleration.

In the lane notification virtual image 15 in the present embodiment, the road surface images 15a are constantly displayed in predetermined shapes substantially irrespective of the road shape in front of the vehicle. Accordingly, even when the number of lanes of the road being traveled by the host vehicle, the position of the lane being traveled, an extended position of the lane, or the like is unknown, the TBT display application 50e can draw the lane notification virtual image 15. As a result, even when it is difficult to acquire the high-accuracy position information and the high-accuracy map information, the displayed guide object 11 can urge the driver to make a smooth lane shift.

In addition, the direction notification images 15b can indicate, using the relative lateral positions thereof with respect to the road surface images 15a having the predetermined shapes, the lateral direction in which the vehicle A is to be moved and the direction in which the vehicle is to exit the guide target point GP. Thus, the lane notification virtual image 15 allows the driver to easily recognize a driving behavior required of the driver using simple display.

Also, in the present embodiment, the display of the deceleration notification virtual image 16 when the vehicle enters the entrance section ES urges the driver to decelerate the vehicle at appropriate timing. In addition, the deceleration notification virtual image 16 can give warning of a level of the traveling speed when the vehicle enters the entrance section ES. Thus, the deceleration notification virtual image 16 can assist the driver to smoothly enter the guide target point GP.

Also, in the present embodiment, as a result of the entrance of the vehicle A into the intersection range PT, the route notification virtual image 17 representing the exit direction is displayed on the road surface in front including the guide target point GP. By thus delaying the timing of displaying the route notification virtual image 17 representing the exit direction until the vehicle reaches the intersection range PT in the vicinity of the guide target intersection, the exit direction represented by the route notification virtual image 17 can accurately indicate a destination road to which the vehicle A is to exit the guide target point GP. Therefore, the driver who visually recognizes the route notification virtual image 17 can recognize the destination road and then smoothly make a right/left turn or the like at the guide target point GP.

Moreover, the display control unit 53 in the present embodiment can adjust the respective values of the display start distance L1 to the exit distance L5 based on the road type information of the road, the congestion information thereof, and the like acquired as the traveling environment information. Through such adjustment, the display control unit 53 sequentially displays the intersection notification virtual image 13 and the lane notification virtual image 15 to the route notification virtual image 17 at timing at which the driving behavior of the driver is required in accordance with a real road environment. As a result, the driver can perform a smooth driving operation based on the presented information irrespective of the traveling environment of the vehicle A.

Note that, in the embodiment described above, the integral display control block 73 corresponds to a “display generation unit”, while the projection range PA corresponds to a “displayable region”.

### OTHER EMBODIMENTS

While the description has been given heretofore of the embodiment of the present disclosure, the disclosure should not be construed to be limited to the foregoing embodiment. The present disclosure is applicable to various embodiments and a combination thereof within the scope not departing from the gist of the present disclosure.

The display of the non-superimposed virtual image in the embodiment described above is ended before the remaining distance equals the switch distance. Thus, a display interrupted period may also be set while the displayed guide object is switched from the non-superimposed virtual image to the superimposed virtual image. Alternatively, the display of the non-superimposed virtual image may also be continued until the remaining distance equals the switch distance. In such a mode, the displayed guide object is switched directly from the intersection notification virtual image to the lane notification virtual image.

In the embodiment described above, the object displayed as the virtual image by the HUD device in the vicinity of the guide target point is only the displayed guide object. However, an object displayed as the virtual image other than the displayed guide object may also be displayed in the vicinity of the guide target point. For example, in the pre-approach section, the superimposed virtual image which warns the driver of a road sign, a pedestrian, or the like may also be displayed together with the intersection notification virtual image. In addition, in a section at a distance to the guide target intersection shorter than the switch distance, a non-superimposed virtual image in the form of an icon obtained by reducing the size of the intersection notification virtual image may also be complementally displayed around the superimposed virtual image displayed as the displayed guide object.

In the embodiment described above, the superimposed virtual image is sequentially switched to the lane notification virtual image, to the deceleration notification virtual image, to the route notification virtual image, and the completion notification virtual image based on the remaining distance to the guide target point. The number of such superimposed virtual images, a duration of the display of each of the superimposed virtual images, and the like may be changed appropriately. In addition, information represented by each of the superimposed virtual images, the shape of each of the superimposed virtual images, and the like may also be changed appropriately. The completion notification virtual image may also be displayed as the non-superimposed virtual image, not as the superimposed virtual image. In addition, when missing of the displayed object by the driver is estimated based on the sensing information obtained by the DSM from the driver, the non-superimposed virtual image and the superimposed virtual image may also be displayed again.

In the embodiment described above, the display permitted range in each of the approach section and the entrance section is limited to a portion of the projection range. Details of such reducing control of the display range may be changed appropriately. For example, the display permitted range in the entrance section may also be set larger than the display permitted range in the approach section. Alternatively, the display permitted range may also be continuously extended with the decrease of the remaining distance. The process of setting the display permitted range need not necessarily be performed.

In addition, an initial shape, an initial position, an extension direction, and the like of the display permitted range may also be changed appropriately. For example, the display permitted ranged may also be laterally extended toward the exit direction with approach to the guide target point. It may also be possible to change a size of the display permitted range based on a parameter different from the remaining distance and the recognition information.

In the embodiment described above, as one of the conditions for erasing the displayed guide object, sensing of the deviation from the travel route is set (see S110 in FIG. 5). As such an erasing condition, sensing of a sign of the deviation from the travel route may also be set. More specifically, when having successfully acquired each of the high-accuracy position information and the high-accuracy map information, the display control device can determine whether or not the lane traveled by the vehicle before the guide target point coincides with the recommended lane based on the route information. When the lane being traveled is different from the recommended lane, the display control device estimates that the vehicle will deviate from the travel route. Based on the estimation described above, the display control device ends the display of the superimposed virtual image which may interrupt visual recognition of a front scene at an earlier time.

The display control unit according to the embodiment described above changes each of the threshold distances based on the traveling environment information. Details of such changing control of each of the threshold distances can be changed appropriately. For example, among the plurality of threshold distances, a specified threshold distance (e.g., the switch distance) may also be excluded from targets of adjustment based on the traveling environment information. In such a mode, the display of the superimposed virtual image is disclosed at a given position at which the remaining distance to the guide target point equals the switch distance. As a result, some drivers may more easily find their rhythms in performing driving operations than when timing for a display transition is adjusted. The changing control of each of the threshold distances need not necessarily be performed.

An input interface used by a passenger such as the driver to change the setting is not limited to such a touch panel, a steering switch, or the like as used in the embodiment described above. For example, the setting of the display permitted range, the individual threshold distances, or the like may also be switched using an input based on at least one of voice/sound and a gesture as an operation by a user. Note that a setting change made by the passenger need not necessarily be permitted.

For example, the HUD device may also be a bifocal projection device which forms a far virtual image and a near virtual image at different positions. In such a HUD device, the non-superimposed virtual image and the superimposed virtual image each described above correspond to displayed objects each displayed as the far virtual image.

An optical configuration of the HUD device can be modified appropriately. For example, for a projector, a configuration including a laser light source, a MEMS scanner, and the like may also be used. Alternatively, a DLP (Digital Light Processing™) using a DMD (Digital Micromirror Device) may also be used as the projector. Besides, a projector using a LCOS (Liquid Crystal On Silicon) or the like, a liquid crystal projector having a liquid crystal panel and an LED light source, or the like can be used as the HUD device.

The display control device according to the embodiment described above is provided as an electronic control unit separate from the HUD device. However, each of the functions of the display control device described above may also be implemented in, e.g., a control circuit provided in the HUD device or may also be implemented in a control circuit provided in a combination meter or the like.

Each of the functions provided by the control circuit in the display control device in the embodiment described above can also be provided by software and hardware that implements the software, only by software, only by hardware, or by a composite combination thereof. When such functions are provided by an electronic circuit serving as hardware, each of the functions can also be provided by a digital circuit including a large number of logic circuits or by an analog circuit.

To the memory device or the like which stores the display control program or the like, various non-transitory tangible storage media such as a flash memory and a hard disk are applicable. A configuration of such a storage medium may also be changed appropriately. For example, the storage medium may also be configured as a memory card or the like which is inserted into a slot portion provided in the display control device and electrically connected to the control circuit. In addition, the storage medium is not limited to a memory device in a vehicle-mounted device as described above, and may also be an optical disk serving as a copier for a program to the memory device, a hard disk drive in a versatile computer, or the like.

The controllers and methods described in the present disclosure may be implemented by a special purpose computer created by configuring a memory and a processor programmed to execute one or more particular functions embodied in computer programs. Alternatively, the controllers and methods described in the present disclosure may be implemented by a special purpose computer created by configuring a processor provided by one or more special purpose hardware logic circuits. Alternatively, the controllers and methods described in the present disclosure may be implemented by one or more special purpose computers created by configuring a combination of a memory and a processor programmed to execute one or more particular functions and a processor provided by one or more hardware logic circuits. The computer programs may be stored, as instructions being executed by a computer, in a tangible non-transitory computer-readable medium. Here, the process of the flowchart or the flowchart described in this application includes a plurality of sections (or steps), and each section is expressed as, for example, S101. Further, each section may be divided into several subsections, while several sections may be combined into one section. Furthermore, each section thus configured may be referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A display control device for a vehicle to control displaying a virtual image to be visually recognized by a passenger of the vehicle, the display control device comprising:
a display image generator that generates a guide object display image for guiding a travel route of the vehicle to the passenger;
a distance recognition unit that recognizes a remaining distance from a current location of the vehicle to a guide target point at which the guiding of the travel route in the guide object display image is provided;
a display controller that: displays a non-superimposed virtual image not to be superimposed on a specific superimposition target as the guide object display image when the remaining distance from the current location of the vehicle to the guide target point is longer than a switch distance; and displays a superimposed virtual image to be superimposed on the specific superimposition target as the guide object display image switched from the non-superimposed virtual image when the remaining distance becomes shorter than the switch distance; and
a region limiter that limits a display permission range, in which the virtual image is permitted to be displayed, to a portion of a displayable region for displaying the virtual image, wherein:
the region limitation unit defines the display permission range to be larger as the remaining distance becomes shorter.

2. The display control device according to claim 1, wherein:
the region limitation unit defines the display permission range to be disposed below the displayable region and to upwardly extend the display permission range.

3. The display control device according to claim 1, wherein:
the region limitation unit changes the display permission range based on recognition information of a front side of the vehicle.

4. The display control device according to claim 1, wherein:
the display controller changes a display mode of the superimposed virtual image based on the remaining distance.

5. The display control device according to claim 4, wherein:
the display controller displays a lane notification virtual image as the superimposed virtual image in an approach section which is defined at a distance to the guide target point shorter than the switch distance along the travel route; and
the lane notification virtual image includes a road surface image having a predetermined shape to be superimposed on a road surface in front of the vehicle and a direction notification image representing a lateral direction, to which the vehicle is to be moved at the guide target point, by showing a relative lateral position of the direction notification image with respect to the road surface image.

6. The display control device according to claim 5, wherein:
the display controller displays a deceleration notification virtual image, which is to be superimposed on the road surface in front of the vehicle, as the superimposed virtual image in an entrance section defined closer to the guide target point than the approach section along the travel route; and
the deceleration notification virtual image is changed into a display mode which provides a warning of a level of a traveling speed, based on the traveling speed of the vehicle.

7. The display control device according to claim 6, wherein:
the display controller displays a route notification virtual image as the superimposed virtual image when the vehicle approaches closer to the guide target point than the entrance section; and
the route notification virtual image is superimposed on the road surface including the guide target point in front of the vehicle and indicates a direction in which the vehicle is to exit at the guide target point.

8. The display control device according to claim 4, wherein:
the display controller adjusts, based on traveling environment information of a road as the travel route, the remaining distance for changing the mode of the superimposed virtual image.

9. A display control device for a vehicle to control displaying a virtual image to be visually recognized by a passenger of the vehicle, the display control device comprising:
a display image generator that generates a guide object display image for guiding a travel route of the vehicle to the passenger;
a distance recognition unit that recognizes a remaining distance from a current location of the vehicle to a guide target point at which the guiding of the travel route in the guide object display image is provided;
a display controller that: displays a non-superimposed virtual image not to be superimposed on a specific superimposition target as the guide object display image when the remaining distance from the current location of the vehicle to the guide target point is longer than a switch distance; and displays a superimposed virtual image to be superimposed on the specific superimposition target as the guide object display image switched from the non-superimposed virtual image when the remaining distance becomes shorter than the switch distance; and
a region limiter that limits a display permission range, in which the virtual image is permitted to be displayed, to a portion of a displayable region for displaying the virtual image, wherein:
the region limitation unit defines the display permission range to be disposed below the displayable region and to upwardly extend the display permission range.

10. The display control device according to claim 9, wherein:
the region limitation unit changes the display permission range based on recognition information of a front side of the vehicle.

11. The display control device according to claim 9, wherein:
the display controller changes a display mode of the superimposed virtual image based on the remaining distance.

12. The display control device according to claim 11, wherein:
the display controller displays a lane notification virtual image as the superimposed virtual image in an approach section which is defined at a distance to the guide target point shorter than the switch distance along the travel route; and
the lane notification virtual image includes a road surface image having a predetermined shape to be superimposed on a road surface in front of the vehicle and a direction notification image representing a lateral direction, to which the vehicle is to be moved at the guide target point, by showing a relative lateral position of the direction notification image with respect to the road surface image.

13. The display control device according to claim 12, wherein:
the display controller displays a deceleration notification virtual image, which is to be superimposed on the road surface in front of the vehicle, as the superimposed virtual image in an entrance section defined closer to the guide target point than the approach section along the travel route; and
the deceleration notification virtual image is changed into a display mode which provides a warning of a level of a traveling speed, based on the traveling speed of the vehicle.

14. The display control device according to claim 13, wherein:
the display controller displays a route notification virtual image as the superimposed virtual image when the vehicle approaches closer to the guide target point than the entrance section; and
the route notification virtual image is superimposed on the road surface including the guide target point in front of the vehicle and indicates a direction in which the vehicle is to exit at the guide target point.

15. The display control device according to claim 11, wherein:
the display controller adjusts, based on traveling environment information of a road as the travel route, the remaining distance for changing the mode of the superimposed virtual image.

16. A non-transitory tangible computer readable storage medium comprising instructions being executed by a computer, the instructions for a vehicle (A) to control displaying a virtual image to be visually recognized by a passenger of the vehicle, the instructions including:
generating a guide object display image for guiding a travel route of the vehicle to the passenger;
recognizing a remaining distance from a current location of the vehicle to a guide target point at which the guiding of the travel route in the guide object display image is provided;
displaying a non-superimposed virtual image not to be superimposed on a specific superimposition target as the guide object display image when the remaining distance from the current location of the vehicle to the guide target point is longer than a switch distance;
displaying a superimposed virtual image to be superimposed on the specific superimposition target as the guide object display image switched from the non-superimposed virtual image when the remaining distance becomes shorter than the switch distance; and
limiting a display permission range, in which the virtual image is permitted to be displayed, to a portion of a displayable region for displaying the virtual image, wherein:
the limiting of the display permission range includes: defining the display permission range to be larger as the remaining distance becomes shorter.

17. A non-transitory tangible computer readable storage medium comprising instructions being executed by a computer, the instructions for a vehicle to control displaying a virtual image to be visually recognized by a passenger of the vehicle, the instructions including:
generating a guide object display image for guiding a travel route of the vehicle to the passenger;
recognizing a remaining distance from a current location of the vehicle to a guide target point at which the guiding of the travel route in the guide object display image is provided;
displaying a non-superimposed virtual image not to be superimposed on a specific superimposition target as the guide object display image when the remaining distance from the current location of the vehicle to the guide target point is longer than a switch distance;
displaying a superimposed virtual image to be superimposed on the specific superimposition target as the guide object display image switched from the non-superimposed virtual image when the remaining distance becomes shorter than the switch distance; and
limiting a display permission range, in which the virtual image is permitted to be displayed, to a portion of a displayable region for displaying the virtual image, wherein:
the limiting of the display permission range includes: defining the display permission range to be disposed below the displayable region and to upwardly extend the display permission range.
